(19) United States
(12) Patent Application Publication
(10) Pub. No.: US 2009/0240737 A1
(43) Pub. Date: Sep. 24, 2009

(54) PROCESS AND APPLIANCE FOR DATA PROCESSING AND COMPUTER PROGRAMME PRODUCT

(75) Inventors: Mark Hardisty, Surrey (GB); Thiel Gunther, Bad Heilbrunn (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: SMAPPER TECHNOLOGIES GMBH, Kufstein (AT)

(21) Appl. No.: 11/721,298

(22) PCT Filed: Dec. 12, 2005
(86) PCT No.: PCT/EP2005/013314

§ 371 Date: Jun. 8, 2007

Related U.S. Application Data
(63) Continuation of application No. 11/040,812, filed on Jan. 21, 2005.

(30) Foreign Application Priority Data
Dec. 11, 2004 (DE) 10 2004 059 755.3
Jan. 15, 2005 (DE) 10 2005 001 988.9

(51) Int. Cl. G06F 17/30

(52) U.S. Cl. 707/200; 707/100; 707/10; 707/E17.01; 707/E17.044; 707/E17.058

(57) ABSTRACT

The present invention concerns an appliance, a process and a computer programme product for the processing of unstructured or semi-structured digital data in a file system. In order to create an appliance, a process and a computer programme product which allow simple, reliable, highperformance and purpose oriented management of every manner of digital, stored, unstructured data, it is proposed that, it is functionally extended by providing a framework for further external logic to be inserted in order to modify the filesystem's behaviour and/or a structure is imposed onto unstructured or semi-structured data in real time by enhancing existing namespace semantics and/or metadata and data are processed independently by physically and logically separating namespace and block handlers.

The present invention concerns a process or a method and an appliance or an apparatus for data processing as well as a corresponding computer programme product.

In the age of the information society, it is no longer the creation, processing and distribution of energy but of information which determines the extent of production leading to economic growth; the information factor has become the main resource. Information forms the basis for decisions and human co-operation. At the same time, however, completely new and separate criteria regarding the quality, cost and use of such information are being applied.

Any form of general data which can be stored falls under the heading of information, that is, language, sound and image data in addition to text and numbers in their respective digital data format and storage forms. Thus, the quantity of available data which may also need to be processed in some way is steadily increasing both in a global sense and for each individual user. Whilst increasing CPU power and new architectures render the creation, processing and transport of an ever-increasing volume of data manageable within a reasonable time frame, the long-term, safe administration of digitally-stored data presents a growing problem despite the fact that sufficiently expanded storage space is available. At the same time, it must be possible to permanently ensure that the information contained in the respective digital data packs can be accessed directly by the user at any time and at short notice as and when required.

Thus managing unstructured data remains an unsolved problem. According to Merrill Lynch, more than 85 percent of any organisation's data belong to that category. Unstructured data refers to data which are hierarchically ranked objects of a closed filesystem, i.e. not extensible functionality-wise. While structured data which represent the form principle of a database provide the means to retrieve information accurately and unambiguously, there have been no similar mechanisms for unstructured data so far. Search engines, classification software and others can be regarded as utilities rather than real solutions and are limited to their individual functionality. Thus it is the task of the present invention to create a process, an appliance and a computer programme product for data processing which allow simple, reliable, high-performance and purpose oriented management of every manner of digitally stored, unstructured or semi-structured data. An appliance or apparatus, according to the present invention, must be capable of being integrated as hardware into all current personal computer and/or data processing environments without basic adjustments having to be made.

According to the present invention, this task is solved by using the distinguishing characteristics of the independent claims. Thus, a method of processing unstructured or semi-structured digital data in a file-based system is characterized in that it is functionally extended by providing a framework for further external logic to be inserted in order to modify the filesystem's behaviour and/or a structure is imposed onto unstructured or semi-structured data in real time by enhancing existing namespace semantics and/or metadata and data are processed independently by physically and logically separating namespace and block handlers.

Any solution according to claim 1 is a system that may create structures in the sense of an extensible framework to advantageously allow search, usability, management and retrieval of information analog to the structured database world.

Further characteristics are subject of the depending claims. Thus a solution according to the present invention may comprise any combination of the following core points to describe a “Network Filesystem Switching”:
1. The extension of the existing filesystem's semantics
2. The physical and logical separation of namespace handling and physical block storage
3. The extension of the filesystem with external, adaptable functionalities, i.e. plug-ins.

On this basis, a process according to the present invention is able to deliver a distributed networked filesystem which is customizable and extendable and uses enhanced filesystem semantics.

However, it is important to note that in a preferred embodiment of the invention it is possible to abolish the existing, prior art separation of logical and physical access to data. When data is accessed, therefore, logical access, i.e. with user-defined criteria, is carried out jointly with physical access, i.e. using the file path. In doing so, a common access mechanism is implemented for both types of access which is particularly constructed so as to remain transparent or, in other words, unperceived by the user. In other words this embodiment presents an extension of the existing filesystem semantics for executing logical and physical access jointly and directly in the sense of not using e.g. further software-tools.

Preferably, a logical access is carried out as access to information by metadata like pathname, timestamps, additional data-intrinsic or even extrinsic metadata and a combination of all. This metadata forms the so called namespace. Physical access is interpreted and executed any way known from the state of the art as access to the bits and bytes being stored on the accessed storage media.

It is advantageous to enhance semantics of an existing filesystem or namespace by a concept of added attributes. Further, attributes may act like files and allow a child relationship to both, a directory and/or a file and/or another attribute. Following this way ah embodiment of the present invention is characterized by the fact that the benefit of this enhanced semantic is the logically grouping of files and attached information, especially in the sense of enhanced metadata. However, in a preferred embodiment of the invention this grouping functionality belongs to the native semantics of the process thus allowing these relationships to be maintained atomically.

The process is carried out advantageously while preserving the atomicity of the sum of all partial transactions regarding all data which is linked to the respective source data and/or files. In this way, all meta data, which has been derived from inside our outside the data, suffer the same fate as the data itself. Consequently, when deleting the original data, it goes without saying that all logically connected data which was derived from the deleted data by means of a process according to the present invention, is likewise deleted.

In a further embodiment of the invention at least one attribute is linked with a data type scheme. This linking allows the introduction of e.g. constraints, validity schemes etc. Further, attributes may be indexed for fast further retrieval, especially using B-Trees, B+-Trees, Hash-tables or the like.

In a further basic embodiment of the invention, arbitrarily pre-definable data subsets are extracted when accessing unstructured and/or proprietary structured data. These extracted data subsets are preferably stored as meta data in a structured form. Thereby intrinsic data subsets, i.e. extracted from the data itself, and/or extrinsic data i.e. derived from outside the data, is used advantageously to create the respective meta data. By use of a process or a method according to the present invention in an embodiment, meta data is created out of arbitrarily pre-definable data subsets, namely on reading and/or writing or, as the case may be, on storing unstructured and/or proprietary structured data. Thus, any form of access to data is used in order to generate corresponding meta data. Thus, arbitrarily pre-definable data subsets are extracted when accessing unstructured and/or proprietary structured data. Further the extracted data subsets may be stored as meta data in a structured form. In a preferred embodiment of the invention intrinsic and/or extrinsic data subsets are used to form the respective meta data. However, advantageously meta data may be created from arbitrarily pre-definable data subsets when unstructured and/or proprietary structured data is read and/or written or stored, as the case may be.

In a preferred embodiment of the invention a file path is processed within the execution of the access mechanism which has been enhanced by a Query-Interface. In a further development of the present invention, the Query-Interface used in the extended file path constitutes an enhancement of a POSIX- or similar standard in the form of an XQuery-Standard or similar standard.

In a further advantageous embodiment of the invention a structure is given to unstructured data by attributes which allows database-like retrieval, such that the query procedure is incorporated into the data path. Further, the filesystem may be extended by external functionality through plug-ins. These plug-ins are referred to as so called SmApplets with reference to the detailed description of embodiments of the invention.

In an important, further development of the invention, data is subject to a pre-defined and customizable rule and action model or framework. In particular, based on the results of the processing of a pre-defined and customizable rule and action model or framework, well-defined decisions and/or actions are carried out. The user is thus given the chance to actively influence the type and choice of rules and actions, for example by modifying the configuration. According to a particularly advantageous embodiment of the present invention, part-programmes or actions of the rule and action model are carried out in the kernel of the operating system, the execution being bound to rules and conditions. Advantageously, this rule and action framework allows the plug-ins to be executed within the scope of the filesystem and/or inbound to the filesystem processing. Further these plug-ins allow the filesystem behaviour to be modified and adapted according to the results of the processing. Thus, this modified behaviour leads to a new logical, but transparent access functionality which is adaptive due to being bound to rules and actions. However, these partial stages may be triggered by well defined events, even events of the filesystem itself. The aforementioned partial stages are executed automatically in a further development of the present invention.

In a preferred embodiment of the invention several filesystems are stacked on top of each other. Advantageously, the stacking of filesystem layers may be done such that the sum of all single transactions in each sublayer can be treated as a single, atomic transaction, where the different filesystem stacking layers all may be executed simultaneously in an asynchronous or sequentially in a synchronous way.

Advantageously, in an embodiment of the invention logical access, which is the access to the namespace, and physical access, which is the access to bits and bytes on at least one kind of storage media, are separated from each other. This separation is hidden from the accessing mechanism. The separation of namespace and block handlers may be done in a physical, out of band way such that the handlers interact using a network backplane. However, this separation of namespace and block code on a network backplane advantageously leads to a granular, horizontally highly scalable filesystem. The new physical block handling concepts may be coupled with existing namespace semantics and vice versa. Further, block handling handlers may be unified in such a way that a virtual block layer may be introduced which allows an existing filesystem to be treated as a physical block device. According to a preferred embodiment of the invention, this block handling unification paired with the ease of coupling with different namespace semantics ultimately is used for a virtualisation of existing storage environments, particularly SAN and NAS environments.

According to a further development of the present invention, a process under the present invention is carried out particularly advantageously utilizing standardized software and hardware interfaces. It is hereby executed as an individual unit without interference in or modification to an existing structure, in such a way that mutual interaction can be avoided should retrofitting occur in an existing system. Accordingly, an appliance or apparatus which implements a process under the present invention is characterized by the fact that resources are assigned to connect the appliance to the standardized software and hardware interfaces of the respective data processing installation or the respective system network. A suitable appliance can therefore be integrated as a closed unit into a data processing installation without interference in or modification to an existing structure of the same data processing installation as it produces its own additional data according to the disclosure of this description.

In an important further development of the invention, the meta data is set up in its own file system on the basis of the common access mechanism. The file system is optimized for the rapid lookup of data content and/or attributes of data content. In this way, this file system is characterized particularly by allowing a bi-directional, atomic interrelation between data and meta data. This means that, by the same token, modification of the data causes a consistent modification of the affected meta data and vice versa. This allows data and its meta data to be processed independently of one another, thus permitting varying views of the original data stream with respect to format, partial-format etc.; however, every modification in one view leads to a mandatory modification in all other views. Thus, it makes no difference whether at least one modification is made to the original data stream and/or one of the attributes as a component of the associated meta data, as any modification is likewise reproduced in the other associated part.

Therefore, an appliance in accordance with one embodiment of the present invention involves a method of encompassing all levels of the unstructured data, from its physical representation through logical classification to its information content, the information content being edited and adjusted to fall within a well-defined framework of actions and/or decisions.

A process in accordance with the present invention is advantageously embodied in a computer programme product, which means, in particular, in any form of data carrier, for example a CD-ROM. Thus, once imported into the main memory of a data processing installation, this computer programme product causes the execution of a process according to one or several of the afore-mentioned criteria.

Further advantages and embodiments according to the present invention as well as a corresponding appliance or apparatus, can be described with reference to an implementation example in greater detail by means of the following diagrams:

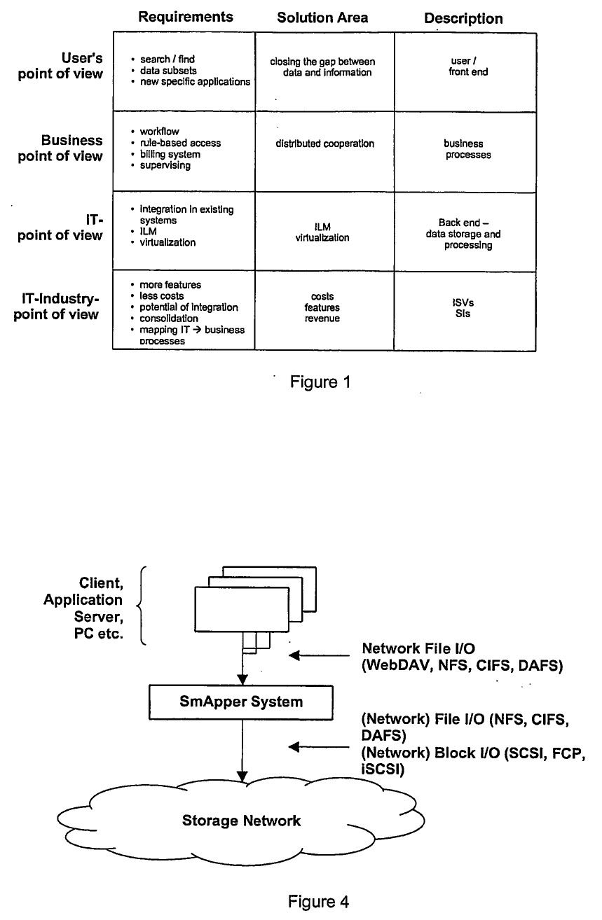

FIG. 1: a systematic illustration of contemplatable solution areas;

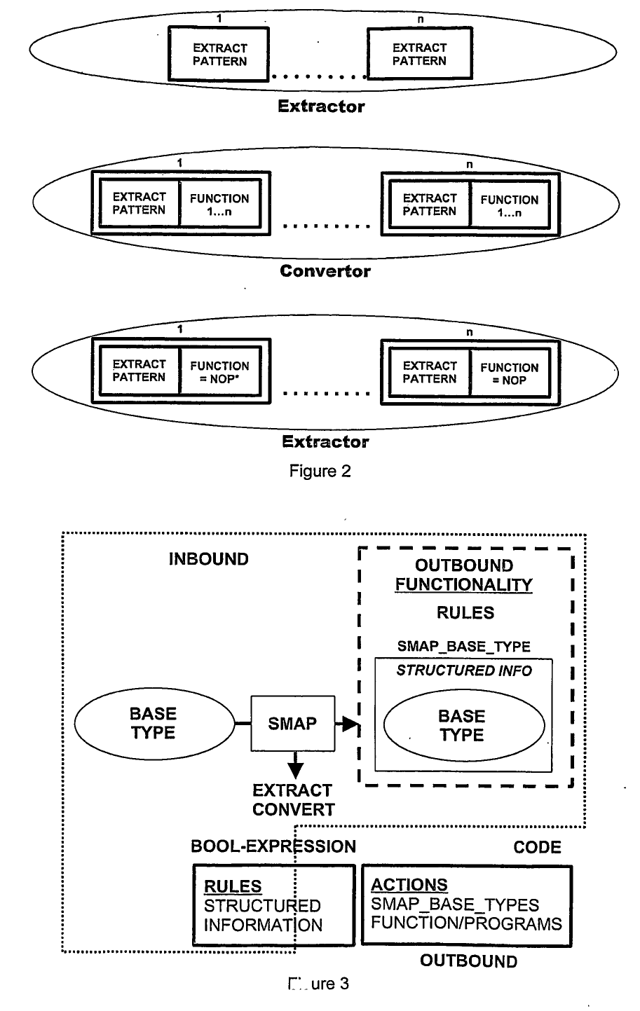

FIG. 2: an illustration of primary methods to answer the question “What does understanding data contents mean”: extractors and converters, extractors being a special form of converters in this case;

FIG. 3: a basic functionality which forms the basis of a process in accordance with the present invention which is named “SmApper”;

FIG. 4: a chart to illustrate the requirement that SmApper must be integrated transparently as an appliance between Storage-Client and Storage-Server;

FIG. 5: a chart as an illustration of stacking as a method which allows the (strictly-speaking) one-dimensional VFS-process to be extended to several dimensions;

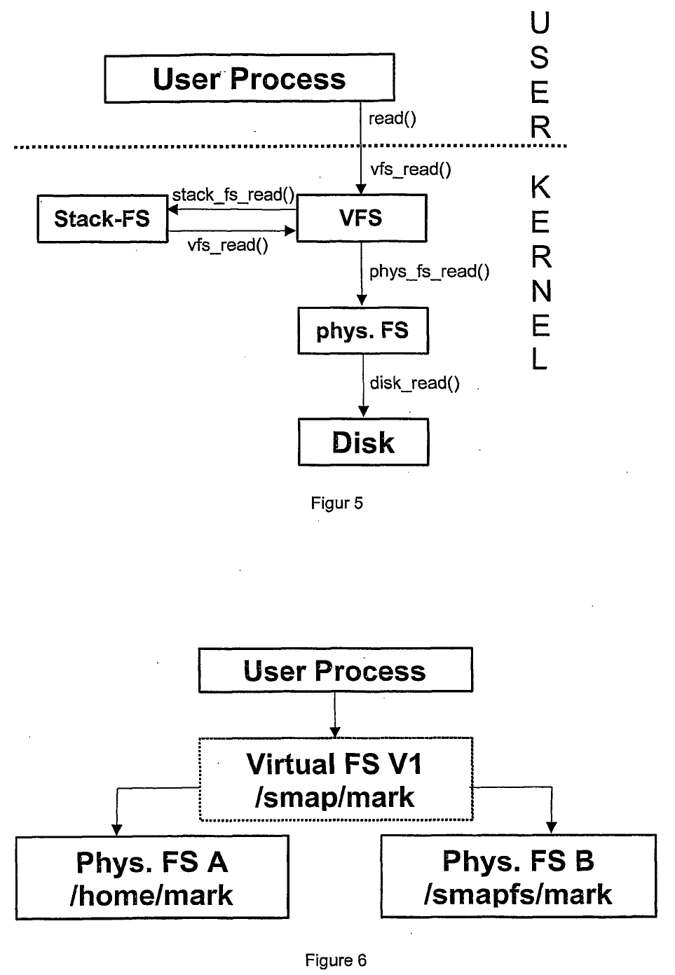

FIG. 6: a chart to illustrate how SmApper uses the stacking procedure;

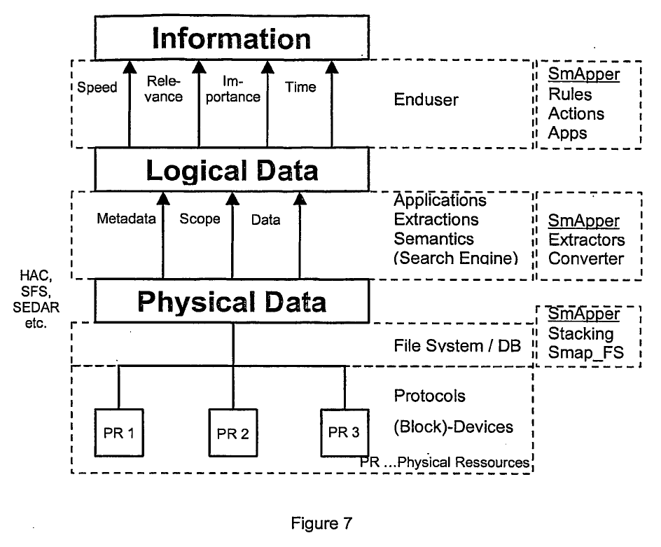

FIG. 7: a diagrammatic representation of how SmApper, as the only meta data solution, spans all layers from the physical representation to the information;

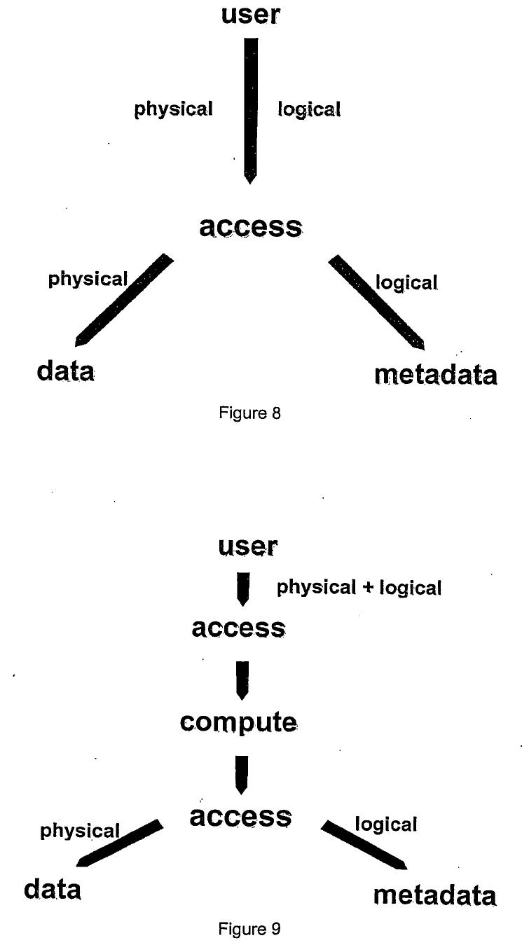

FIGS. 8 and 9: representations of SmApper's fundamental features as a tool to monitor and control unstructured or semi-structured digital packs of data and

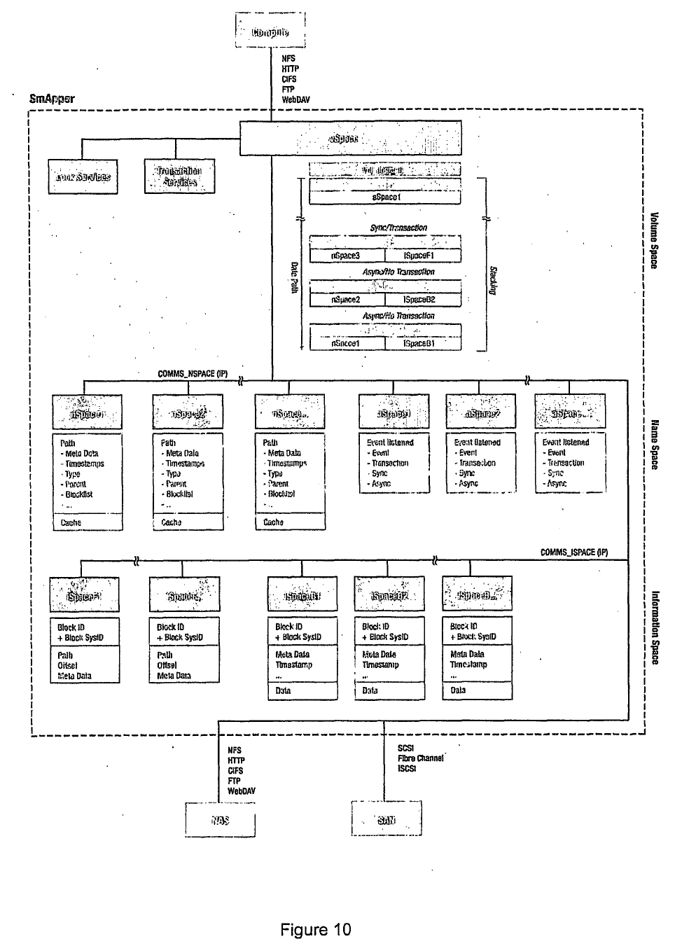

FIG. 10: a diagrammatic representation of how SmApper controls the communication within different stages or levels of data.

The following will serve as a systematic examination of the chosen approach to the management of unstructured data by means of structured meta data:

### 1 THE PROBLEM BACKGROUND

### 1.1 The Structural Challenge

One of the most challenging information technology issues is the management, the usability and the retrieval of the stored data in an enterprise or organisation. Today, a single company's storage resource capacity is measured in petabytes; from a global point of view, the 10¹⁵ bytes or Exabyte limit has been surpassed years ago. However, data is not just data, it's segregated into structured and unstructured data. Structured data couples content and form or format. A database or database tablespace represents the form. The content of a tablespace entry can be classified by the description of the tablespace such as “town” or “customer number” and therefore achieves a certain quality.

Unstructured data has a file format and are objects of a filesystem. The application which created the file dictates its form, however does not necessarily exactly reflect the content. Files can contain images, audio, graphics or text or a combination. The filesystem provides the hierarchical sequence of the files and allocates each file a dedicated path to its storage block. Every file can be found by following this path. This methodology lays the ground for a severe problem: In case the path and/or file name is unknown, the search for information is aggravated, if not made impossible. Another difficult point is that filesystems are proprietary, i.e. there is only very little or no room for individual enhancements. While it is easy to search and retrieve information from structured data, i.e. data stored in a database, by using query tools, there is no such mechanism for unstructured data so far. Search engines, classification software and others can be regarded as utilities rather than real solutions and are limited to their individual functionality.

### 1.2 The Management Challenge

A comparison of the quantity ratio between structured and unstructured data shows the explosiveness of this management challenge: According to Merrill Lynch, more than 85 percent of an organisation's data contributes to the category ‘unstructured data’. As there is no central control available which is able to manage unstructured data using standardised and widely automated mechanisms, every point solution remains shortfall. Questions such as Which data do we have? Where is it stored? Who is using it? Which data is undesirable or as is the case with zombie data dangerous? cannot be answered from a global point of view.

The consequences are not only massive losses in productivity. Gartner Group analysts assume that employees spend 30 to 40 percent of their working time with managing (unstructured) documents. Back in 1997 it was only 20 percent. The reason for this increase grounds in the immense data flood and its lack of manageability. Further consequences are e.g. negative cost effects due to unseized storage consolidation opportunities or additional staff expenses as soon as control bodies or governmental agencies require information at short notice. Thus, it is not enough to operate superficially for a basic and uniform optimisation of the management, the usability and finally the value of unstructured data: The point of departure must be the organisational principle of unstructured data, the filesystem.

### 1.3 The Starting Point

The resource information has become a decisive factor for production in the age of the information society. According to the study “Data Powers of Ten” [1] we produce new information with a capacity of one to two exabyte per year. This equals about 10¹⁸ letters, or, in other words, almost all the words that have ever been spoken. Information is the basis for decision processes and human cooperation, which is one of the main reasons for the importance of digital information as a production factor. This information, however, is completely subject to personal criteria concerning quality, cost and benefit. Today's information and communication IaC technologies make information almost universally available without losing any of its individualization, depth or interactivity. If you know how to use this resource, information, and above all digital information, may be the most important asset of a company. Modern IaC systems make this possible.

Current IaC systems basically comprise three components: data processing, data transmission and data storage according to Gartner, IDC and Forrester IT departments already spend more than 50 percent of their hardware investments on data storage systems. Data storage systems have been optimized to store data and make it available. From a technical point of view the nature of data is insignificant. Radiographs, family pictures, emails, letters of financial data are all treated the same way. Intelligent handling of digital data today is still based on the application, i.e. the many specialized programs and software such as SAP, Microsoft Word, Adobe Photoshop etc.

The majority of today's digital information is rich media data, with content such as pictures, video, sound, graphics or other non-text based information. It is only meta data that makes them available for processing and commercial use. Examples of such meta data is contract and legal information, serial numbers, forms or comments that are needed for administration, easy location of the data and its appropriate usage.

At present the administration and usage of the relevant meta data and the original data are completely isolated from each other. There is no consistent standard to regulate how meta data and data can be stored and administered together. Meta data is stored in the same way as the original data as the storage infrastructure does not recognize any difference. However, meta data is usually more important for the cooperation than the original data. Thus it is almost impossible to administer, let alone find, unstructured data that cannot be saved into a database, e.g. addresses. Various solutions to deal with this problem do exist, but they either deal with a restricted type of data, are proprietary and expensive or optimized for a very specific use. In most cases there is simply no all-encompassing solution available today.

### 1.4 Solution Areas—The System

The simple and purpose oriented management of digital data is one of the biggest challenges currently faced. To solve this problem you have to examine the specific interests and needs of each of the following groups:
Users
Business management
IT specialists/systems
IT industry

### The User's Point of View:

Simple, fast, direct—users want to find and read the information that is relevant to them without paying too much attention to the details of the technical solution. They don't want to be overwhelmed by an endless flow of information, but they want exactly the data they need for processing and that is relevant to their specific work area. If you have no CAD software installed you have no use for an Autocad file. Furthermore, data must be up-to-date. We all know the problem faced when trying to retrieve a word document that has been saved under various names (abc_{—}1.doc, abc_{—}2.doc 2_abc.doc etc.) but without any indication of the latest version.

### The Business Point of View:

The core issue concerning digital cooperation for a company is: how do we make sure that the right data of the right quantity and quality are in the right place at the right time? Data has to be transferred between a company's organizational units based on business related rules. This process specific approach has to be independent of the underlying IT infrastructure- and especially the storage infrastructure.

### The IT Point of View:

The “Information Lifecycle Management ILM” describes the main requirements of IT systems. Data has to be made available according to its functional use and relative importance. It is essential to understand the workflow between single departments and units concerning data exchange and the quality requirements for data storage, e.g. availability, speed of access, quality data such as image resolution etc. Also, all these requirements should be reconciled with the total cost of ownership TCO of data management, i.e. what costs incur to provide data of the category x.

For example: A company has to store financial data for several years due to legal requirements. However, you do not expect that every single subsidiary needs high speed access to this data at any given time. Storing this data on tapes, CD-ROMS and the like is a totally adequate method of archiving it.

A new way of object and data oriented data management can only be successful if such tools or systems can be smoothly integrated into the existing infrastructure.

### The IT Industry's Point of View:

Today the success of new products or new technologies are based on the coordination with big software producers, ISVs such as SAP, Oracle etc., and system integrators, Accenture, CGEY, Bearing Point etc., who recommend the appropriate IT infrastructure needed to solve business problems. Intelligent data management can be detached from the application itself thus resulting in leaner applications with a better cost-effective development process. Data management usually is no longer the core competence of ISVs, so new features based on this might now be realized while they had to be cut before due to the high costs. From the system integrator's point of view rule based data management especially with regard to the Information Lifecycle Management can offer big potentials for professional services. In such a data management scenario system integrators also attach great importance to the idea of infrastructure consolidation concepts and an improved projection of business processes on IT processes.

The solution system can be summarized in the diagram of FIG. 1. If you look at how these requirements are met today you will find an overlapping of various markets and solution approaches. There are different solutions from the point of view of manufacturers of infrastructure components (above all data storage systems, operation systems and file systems, databases) and manufacturers of applications and user software (Content Management Systems CMS, file management systems FMS, Information Lifecycle Management Systems ILM or Backup/Recovery Tools and Workflow and Collaboration Systems).

The diagram of FIG. 1 describes the overlapping of the different solution approaches.

### 2. THE SOLUTION

### 2.1 Extension of the Existing Filesystem Semantics—Database Versus Filesystem

Traditional filesystems work with the three categories directory, file and link, the latter having not more than a utility function. Due to the strictly hierarchical tree structure of a filesystem there are unambiguous parent-child-relationships. All parents belong to the category directory. Children can be a directories or files. A sequence of directories plus file name defines the path leading to exactly this file.

Databases, which represent the class of structured data per definition, follow totally different relationship principles. Ultimately they address three levels:
1. the physical definition of the structure fitting the target storage hardware
2. the definition of a logical structure representing a data scheme (data type, tables and relationships between the tables)
3. the way of the internal processing (by using triggers, stored procedures etc.) see suggestions for extendability of existing filesystems below.

The logical structure dictates the frame and defines e.g. an address dataset and which data types compose such a “new data type” or table. So-called constraints provide the conditions of the tables, such as the commitment to certain keys, compulsory table spaces, validity areas etc. It is for example possible to define the validity of a table space entry: Shall a table space xy always contain a numeric value or are letters accepted as well? How many characters may it contain? etc.

Referential constraints provide the relationship between the tables. While one table contains the names and numbers of customers, a second table may comprise the addresses. A referential constraint matches both and delivers finally customer addresses. Another point is the relationship between the tables: Are they unambiguous or ambiguous. A typical example: May a customer have more than one address and vice versa or not? What happens if a part of the address is deleted? How does this affect other datasets involved? A database executes the necessary internal checks to meet the defined referential constraints and is able to deny rule violations and to block any attempt to save the data on the storage device. Ultimately, the variety of possibilities is only limited by the characteristics of the database product, such as e.g. SQL server, Oracle, DB2 or Informix.

### 2.2 Attributes Extend the Filesystem Semantics

A filesystem does not go beyond the physical definition of the first level and only organises the data's allocation on the storage device. There is a total lack of an inherent logic which is comparable to a database's logic. To balance this shortfall and transfer the benefits of structured data to the filesystem principle, SmApper extends the three already described category types by a fourth type, the so called attribute.

An attribute acts a) like a file and allows b) a child relationship to both, a directory and a file plus another attribute. Therefore a file gains the character of a directory which collates attributes—but no files.

The hierarchical directory/file sequence of the filesystem semantics has been enhanced by an attribute and looks e.g. like:
Home/gunther/smapper.doc@title
directory
   file
      attribute

The benefit of this enhanced semantic is the logical grouping and aggregating of files and attached information especially in the sense of enhanced metadata. As the grouping functionality belongs to the native semantics of the (SmApper) filesystem, these relationships can be maintained atomically. This means for example that a file can only be successfully deleted when all related attributes have been deleted as well.

Attributes can be linked with a data type scheme. Referring to the example above, it can be guaranteed that “title” allows only letters. Furthermore, it can be determined whether “title” may contain a blank or that it is limited to a maximum of 20 characters. This refers directly to the constraint concept of the database world.

### 2.3 Virtual Folders

By using the concept of virtual folders, it is possible to combine two methodologies which at first glance seem to be contradictory: the hierarchical path methodology of a filesystem and a query language's algebra of sets. A path simply leads to a single file. However, the search for data with a specific characteristic or feature provides x results which are all part of an entity: x C E represents for example all customers in a selected postcode area E. The virtual folder allows this kind of query within a filesystem. Here, the query targets key terms of the attributes instead of database tables. SmApper uses xQuery as the query language, a standard of the XML community, which can locate any point in an XML document. A user generated query finally creates a virtual folder bundling all files that meet the query criteria. There is no specific software or knowledge required to start queries as the query statement can be combined with a POSIX compatible path.

Thus, SmApper gives a structure to unstructured data which allows a database-like retrieval process. One very important point of this concept is the integration of the query procedure into the path.

### 2.4 Separation of Namespace and Block Code

The following observations require an understanding of the key terms ‘filesystem’, ‘namespace’ and ‘metadata’ as well as their context. Filesystems such as the original UNIX filesystem UFS which was developed in the 1970s, its later version Berkeley Fast File System FFS which appeared in the 1980s or Microsoft's proprietary filesystem NTFS are implemented as operation system OS routines. These routines manage the directories and files and allocate physical block storage. Filesystems represent the hierarchical structuring of what is otherwise an anarchic depository of files while visualising the system.

Key elements of a filesystem are the so-called namespace and the allocated block code. Both provide the means to find, read and write every file. The namespace contains a file's name and metadata and directs the way to its physical blocks on the storage device. The block code handles the physical organisation of the data bits on the storage device. The term metadata, as used in the field of information technology IT, is relatively new. However, the basic principle has been applied in archives and libraries for centuries to enhance the description, the categorization and retrieval of information resources. Speaking in terms of the IT world, the metadata of a file comprises file name, access rights, the date of the last modification amongst others.

Filesystems are not just closed systems, but often integrate namespace and block code as monolithic blocks. The reason for that can be found in the development of the UFS, the standard for UNIX filesystems, see [18-22] for further reference. As it had reached its limits, the first version UFS1 was revised after several years. Along with functional enhancements, the next version UFS2 separated the code basis for the namespace part and the block part into two independently operating instances which can nonetheless be merged. This separation allowed two major steps: It became possible to carry on with the semantics of UFS1 while independently optimizing the physical organisation of the data blocks on its storage device. Therefore UFS2 still contains the namespace code of its predecessor UFS1. The block code, however, is handled by a new filesystem store called Fast Filesystem Store FFS. Furthermore, this separation makes it possible to replace the block organisation code at anytime to address specific needs of a storage device. However the design and implementation of UFS2 missed one crucial point: OS independence. As a result, there is no horizontal, “out-of-bound” scalability for the single tasks of the filesystem.

If the handling of metadata, especially regarding the file look-up, and the access to physical data blocks—which define a filers content—scaled separately, a granular scalability would arise which is not possible today. If this separation happened in such a way that several instances of each code handler were able to run in separate physical compute nodes, e.g. server blades, a horizontal out-of-band scalability would occur. Usually, it is only possible to scale in an “inband” way by adding new processors because all handling happens within the OS kernel. In other words, SmApper makes it possible
a) to separate both building blocks of a filesystem and
b) link its handlers over an IP-based infrastructure.

This ultimately results in a granular, horizontally scalable filesystem which uses Ethernet as the backplane instead of the internal bus of a single computer.

### 2.5 Extendability of the Existing Filesystem Functionality with Plug-Ins

The variability and changeability of unstructured data causes different symptoms when it comes to the management—see the management challenge chapter above. Islands of information, lack of knowledge about what, where, how and why data is stored, data redundancy, security gaps, boundless growth and policy violations are the most frequent occurancies. No two enterprises are exactly the same so that symptoms may vary and may be more or less pronounced as an example can easily prove.

Today, many companies struggle with the data redundancy problem. However, the severity of this problem is determined by the decision regarding when a file is redundant and thus when it could be de-duplicated. De-duplication means eliminating duplicate and multiple copies of stored data without losing information such as rights, properties and access paths. Even if a file is just opened and instantly closed again its metadata is changed; MS Word for example automatically updates the date and time of the last access. Although the content has not been altered, the file is no longer the same due to the adjustment of the metadata. Then the question arises whether the changes in the metadata should be reported—e.g. due to privacy or compliance reasons—or should only the file's content be the sole criterion. Whether de-duplication occurs or not depends on the criteria applied in each case.

At this point it is already evident that there cannot be a universal key to solving all problems of managing unstructured data. A successful concept for optimising the management of unstructured data must provide a platform in the form of a framework which can be created and customised individually to address an enterprise's specific, sometimes changing issue(s).

### 2.5.1 SmApplets

SmApper delivers on this promise with the so-called SmApplets, deriving from the term Applet. An applet describes a small, mostly Java-based application that is executed on a compute target and is subject to particular constraints such as specific security policies. A SmApplet represents code which is integrated into the SmApper framework by using the sandbox methodology. A sandbox is a protected space where software processes can run without affecting their environment and also serves as a security measure. The idea behind the SmApplets is the application of the database modality of ‘stored procedures’ to SmApper's extended filesystem.

A SmApplet comprises two components, an executive layer and a rule-based layer. If a pre-defined event occurs, a pre-defined action is triggered. To achieve further granularity, this action can be enhanced by applying a filter to for example a dedicated date, a user group, a time or a key word. Obviously this approach is very similar to a database's stored procedures: Database vendors provide a programming language for their product which allows the writing of scripts that run automatically after being triggered. Within the capabilities of the programming language, stored procedures are programmable at will and open up the possibility of extending the database by a behavior-controlled, automated mechanism. SmApper makes use of this peculiarity with its SmApplets.

### 2.5.2 Implications

As SmApplets are universal and open, they can form the base for policies which are definable at will. Having said this, any action can be executed with and to the ‘unstructured data’ which is now structured thanks to SmApper's filesystem. Taking business aspects into consideration, the previously unmanageable data becomes manageable for existing enterprise business processes-directly within the filesystem. SmApper's principal mission is not to write SmApplets but to deliver the necessary platform and the SmApper filesystem. Independent software vendors ISV have the opportunity of developing dedicated plug-ins for specific issues which can be integrated into the filesystem as extensions, thus making it more intelligent. One and the same problem varies slightly from customer to customer and is prioritized differently so that a solution should be fully customizable. The system is able to deliver on this as there are no limits to programming and defining SmApplets.

A SmApplet-based rule engine can solve various problems. Here are a couple of examples.
1. DeDuplication: elimination of duplicate and multiple copies of stored data without losing information such as rights, properties, etc.
2. Migration Services: transparent data movement and migration as well as intelligent replication
3. ILM: classification of data and selection of the most economic storage according to the value of data throughout its lifecycle
4. Secure Campus: correction of rights to enforce security guidelines and protect corporate values
5. “Post It”: virtual attachment of a “Post-It” to any kind of file without changing it
6. Audit Trails: tracking of any changes to files. Detailed reporting and statistics and automated audits in real-time help to monitor compliance

### 2.6 Brief Definition of the Solution

In order to create a system that integrates all approaches mentioned above and makes them compliant with the heterogeneous requirements we assume that in principle the following solution is needed:
Ubiquitous data access must be possible.
The system must be able to understand the contents of the data and manage it accordingly; it must be possible to create meta data.
Rules must be set to manage data on the basis of business processes.
The solution must fit perfectly into the existing infrastructure, it must be scalable and expandable.

The system shall allow data management of the next generation, namely at the location where the data are stored. Thus the solution must represent a transparent expansion of the storage infrastructure and not be just another business application, e.g. Enterprise Content Management Systems.

The key component of the solution is a layer that allows business rules to be defined and to directly and easily map not only data and meta data, but also their management, storage location, life cycle and flow.

### 2.7 Detailed Requirements

In order to fulfill all the requirements for digital data management discussed here, the following basic solution requirements (afterwards also called system) must be reconciled irrespective of the manner of implementation:

### Administration of Data and Meta Data

The system is designed for unstructured data, that is, for the administration of files—and not for databases, records and so on
Data and its meta data must be treated as a single unit
It must be possible to separate the access, administration and modification of data and meta data
Each modification of the data must be reflected in the meta data and vice versa where feasible and appropriate
It must be possible to create meta data automatically from the source data
It must be possible to create meta data manually, that is by interaction with the user
It must be possible to define which meta data should be created from the source data
The system must be able to ‘learn’ new datatypes at any time
It must be possible to integrate external datatype-modules from other datatype specialists into the system (in compliance with pre-determined syntax and semantics) without compromising the quality of the whole system
The system must allow datatype conversion and abstraction
It must be possible to retrieve meta data, or a definable excerpt from the meta data, via a ‘Query-Language’
Meta data, or a definable excerpt from the meta data, must be capable of being exported automatically into non-system environments, e.g. like billing applications, SAP-Systems etc.

It must be possible to provide several versions of the same data—each version clearly distinguishable from another—and to be able to assign accurately the relative modifications of this data and meta data, with respect to content, origin and time.

Smooth Integration into existing Environments
It must be possible to store data in the usual fashion without mandatory modifications to the client and/or server.
The system must not impair existing security standards
The system must be scalable in such a way that no existing Service Level Agreements SLAs are lost or forfeit
It must be possible to continue to use existing data storage systems, networks and other infrastructure components
It must be possible to integrate new technologies, in theory at least, particularly with regard to storage aspects
Access to data and meta data must be possible regardless of location within the framework of the given infrastructure

### Virtualization

Rules must be able to describe which data should be stored physically at which location and how often
This physical storage location must be allowed to change even during the life cycle of the data, contingent upon definable rules
The physical storage location must remain discernable for access

### 3. SOLUTION DESIGN

### 3.1 Concept of the Base Types

SmApper focuses on file-based data. At this point, the construction base_type is introduced as a simpler abstraction of the term file. A base_type is most easily comprehended by borrowing from the object-oriented design approach. According to this model, a base_type is a class with well-defined properties, that are designated as attributes in the following sections, and methods. A base_type is nothing more than the logical encapsulation of any file—in theory.

Thus, a base_type has as its primary attribute the binary representation of the data contained in the respective file. Further attributes are, for example, date fields, which indicate when the data was last accessed or modified and so on. The methods provided by a base_type include, in particular, the capability to access this binary data, to modify it and render the respective condition of the data persistent (in the file). A base_type is a logical construction, which is not made persistent in itself but is merely a medium of describing a physical file and the methods which can be applied to it. At this point it should be noted that the distinction between a file, which is itself only a logical construction of a file system—in order to classify the actual physical blocks on the respective secondary storage system—and the actual physical data characteristics—of the blocks—has been waived in the following sections.

A base_type and its methods and properties depend, therefore, on the respective file to which this construction is applied but also, of course, on the capabilities of the fundamental file system. The actual instantiation of a base_type results in an object with an allocated file. The following will serve as an illustration of the base_type using C++ class, which is however not fully implemented:

public class base_type {

public:

// con/destruction
base_type(const char * filename);
^{~}base_type( );
//methods
ssize_t read(...)
ssize_t write(...)
ssize_t lseek(...)
etc.

private:

// pointer to opaque data stream
void *m_data;
// where is my physical file
const char *m_path;
// Filedescriptor
int fd;

}

One of the basic requirements of the system is that it considers data and meta data as a single unit. For this reason, a new data type is introduced on the basis of the base_type known as the smap_base_type. The smap_base_type is an extension of any base_type and can be best described using the term inheritance. A smap_base_type is derived from a base_type and then adds extra methods and attributes. Thus a new, autonomous, encapsulated data type is created, which represents the foundation for all further discussion in the following sections. Each SmapType has a number of attributes <0, n>. For example ‘pages’ which could be the number of pages in an MS-Word document.

Attributes may have base_type-intrinsic values abstracted from the base_type or extrinsic freely-defined values. Every attribute has an explicit qualifier UID and is classified by a data type. This could be either simple data types like int, char etc. or complex data types like string, smap_base_type etc. Each attribute possesses a value that corresponds to the data type as well as additional parameters which describe further properties of the attribute. One example of the use of such a parameter is scope=system, which indicates that the attribute is a system attribute that may be read only and not modified by the user. Moreover, attributes can be constructed hierarchically, e.g. there could be a subtitle in a document which forms a child-relationship to a title-attribute. A smap_base_type offers methods for reading, setting, numbering or iterating values.

### 3.2 Extractors and Converters

As one of its core requirements, SmApper needs to be able to understand data in form and content in order to allow customizable decisions on the basis of this information. What does it mean to understand data in form and content? Well this will vary from one case to another. In one application context ‘comprehension’ may simply entail extracting the number of pages of a Word document from its binary representation. In another context it may be necessary to extract the titles of the individual chapters.

In a more general sense, data comprehension can be defined as follows:
1. Two methods are applied to the binary stream:
   data is extracted
   optional: specific function is applied to the extracted data (=convert)
2. The new data set thus created must conform to a well-known data type to which well-defined operations can be applied.
3. This data set must be associated with a context.

FIG. 2 shows a diagrammatic representation of both methods: the Extractor and the Converter. As demonstrated in the diagram, an extractor is a set of extract patterns which determine how much of which data is to be extracted to which location within a binary stream. A converter, on the other hand, extracts data and then applies a function on it. On closer examination of this diagram we see that an extractor is a special form of a converter, and is in fact a converter with a null-function per pattern. Thus, extractors are a special form of converters.

With the assistance of the base types constructions and the above-mentioned converters and extractors, we are now capable of examining in greater detail the basic functions that SmApper offers in the next section.

### 3.3. SmApper—Basic Functions

FIG. 3 demonstrates the basic functions that SmApper provides. These basics, which will be examined in depth in the following sections, form the SmApper core system, with the aid of which the actual modules (or applications) can then be developed. The main tasks of the SmApper System are as follows:
1. To generate a smap_base_type out of a base_type by means of converters and extractors.
2. Access to the smap_base_type (the actual file and the attributes)
3. Additional functions on the basis of smap_base_types (rules, actions)

When extractors and converters are applied, the data subsets generated are assigned to attributes of the smap_base_types and hence are brought into the correct (is to say definable) context. The manner in which the smap_base_type manages its attributes guarantees the data integrity of the individual attributes. Or, to put this a different way, this means that SmApper appends structured data to unstructured data.

Access to the attributes of a smap_base_type must be possible by direct means and must, in addition, permit a Query-Interface in order to locate attribute contents.

Rules enable the forming of Boolean Expressions on these attributes by means of attributes and permitted operators which show ‘True’ or ‘False’ as a result. Rules access solely the structured information of the smap_base_type thereby offering the possibility to reach a decision based on the data. According to FIG. 3, rules run inbound as well as outbound. Inbound means that the affected system component runs in the kernel space of the SmApper (basic) operating system while outbound means that the scope of the code segment is user space. Please see Section 4.1 for further information.

In turn, actions enable programmes to be executed on the basis of events and conditions or rules, in order to initiate corresponding operations.

Together, rules and actions form the crucial unit enabling decisions to be reached and actions to be carried out on the basis of available data. The fundamental lemma, on which SmApper is based and which, in addition, permits a distinction to other implementations of related problems, reads as follows:

SmApper guarantees the complete integrity of the smap_base_type. As soon as any modification to the base_type is made, SmApper displays this automatically for the user and/or the application programme atomically in the smap_base_type. In the same way, any (permitted!) modifications to the smap_base_type or its attributes are automatically as well as atomically displayed in the base_type.

### 3.4 Network File I/O and Appliance

It is one of SmApperrs basic requirements that it must be able to integrate itself smoothly into existing infrastructures—see the chapter of a brief definition of the solution above. Moreover, SmApper restricts itself to unstructured data, meaning file data. In addition, it must be possible to access the data from any point in the network at any time. These requirements make it absolutely essential to apply one of the basic requirements to the implementation as follows, particularly while taking the detailed requirements into account, see the chapter dealing with detailed requirements above:
SmApper focuses on the Network File I/O
SmApper must be integrated smoothly into the Network File
I/O communication, e.g. CIFS, NFS, DAFS, WebDav.

This is only possible without modifying the Client/Server and Storage Infrastructure by installing a Black Box (appliance) that is integrated “invisibly” into the data traffic between Storage-Client and Storage-Server.

The diagram of FIG. 4 shows these basic requirements of SmApper

### 4. SMAPPER—THE IMPLEMENTATION

SmApper must be able to handle every Network File I/O protocol for Storage-Clients and for Storage-Servers even every storage protocol (file and block) must be handled. In addition, SmApper must have the ability to switch into the communication between Storage-Client and Storage-Server, in order to implement its additional functions smoothly. The only technical alternative which permits such a procedure without re-inventing the wheel each time and without having to integrate itself into every imaginable protocol stack, is known as stacking [2, 3, 5].

### 4.1. Stacking and VFS

Before we can explain the meaning of the term stacking, it is necessary to define the meaning of VFS. VFS stands for Virtual File System and stands for a layer, which has become a standard part of modern operating systems and which enables the homogenization of access to heterogeneous physical filesystem implementations. VFS is a term from the Linux kernel which may be known by a different name in other operating systems and which, by its nature, is implemented differently, for example the VNODE-layer under SOLARIS, however, the purpose of this layer is always the same. When we talk about VFS in the following paragraphs, we mean the underlying concept and not the Linux-specific implementation.

A modern operating system must support a wide array of different file systems: local file systems like NTFS, UFS, XFS, ReiserFS, VxFS, ext2/3, FAT, CD-ROM file systems, to name but a few. In addition, there are network file systems like NFS, CIFS, DAFS, coda and others.

In order that an application does not have to control the different implementations of the individual file systems, the operating system core (kernel) abstracts the underlying physical implementations with the help of the VFS-Layer and compels the physical FS-implementations to abide by a. set of pre-defined functions, which may be optionally implemented to some degree. The VFS-Layer then ensures that each implementation of the necessary function(s) of the physical file system is retrieved when accessed [6, 7, 2]. Although the individual kernel implementations were not developed with the help of object-oriented language tools, on closer examination this concept is about Function Overloading which can be easily demonstrated therefore by Virtual functions. Thus, the VFS-Layer makes a set of virtual functions available, which (can) then be overwritten by the real implementations.

Stacking constitutes a process that avails itself of the VFS concept intensively and, in doing so, extends the process. A conventional VFS implementation primarily allows for a VFS-Layer that can retrieve N file systems. Stacking, however, facilitates the retraction of the M VFS-layers as a matter of principle, in which the VFS-layer at position M retrieves the VFS-layer at position M−1 and so on until the actual physical implementation of the underlying file system(s) is retrieved [4].

FIG. 5 illustrates this process showing, that stacking is a method which allows the expansion of the primarily one-dimensional VFS process into a multi-dimensional one [4].

A tangible alternative to the stacking concept is the one that SmApper applies in order to control the problem of smooth integration in the communication paths between user-defined Storage-Clients and Storage-Servers. As FIG. 6 shows, SmApper applies the stacking process in order to provide the user/application programme with a virtual file system, which the user perceives as an actual physical file system. This virtual file system masks two (in principle n) actual physical file systems, namely Phys. FS A which, in our illustration, constitutes the actual path and storage-server the user wishes to access. Phys. FS B of FIG. 6 denotes the so-called QZone (see the section entitled QZone and Caching below) of a SMAP_FS (see section entitled SMAP_FS) where the smapbase_type for every relevant file retrieved by Phys. FS A is represented in terms of functionality, as demonstrated in the chapter treating SmApper basic functions above.

### 4.2 QZone and Caching

One of the essential basic functions of SmApper is the ability to generate data subsets out of the original data stream with the help of the illustrated extractors and make them persistent as smap_base_type-attributes using the SMAP_FS. SmApper makes it possible to execute the extraction completely inbound (that is, while the data stream is being generated or modified and so on) or outbound. The latter is particularly important as there are certain extraction procedures which require too much time to be executed inbound. In this case, or if specified by the user, the data extraction must be effected once the I/O operation has been completed, i.e. in an asynchronous manner.

According to FIG. 6 SmApper applies the stacking process in order to combine all user-defined Phys. FS As with all Phys. FS Bs (QZone of a SMAP_FS) thus guaranteeing the persistent connection between a base_type and a smap_base_type.

As the extracted data could lead, in connection with rules and actions (see the section on rules and actions), among other things, to the physical storage location, the mode of storage of the original data, the security attributes etc. being modified, the original file must be buffered in the meantime. SmApper provides the so-called QZone (quarantine zone) for this purpose; this constitutes a physical location which meets all requirements (availability etc.) and offers, preferably, a high-performance file system.

The QZone is not only essential in order to permit outbound-mApping but offers further advantages, as it can be regarded as a caching-entity. To with, SmApper has its own QZone-daemon which determines the specific time that the actual physical displacement of the buffered data to its designated destination (target-destination, as defined by the user at the original I/O) should take place. The parameters for this decision can be as diversified as with any other I/O operation on a SmApper system. Moreover, it is of course possible to displace the data to any other physical location, as the SMAP_FS can restore the connection to the original path at any time. An example of such a purposely delayed displacement out of the QZone would arise if the QZone were accommodated on a Nearline-Storage-System where files could remain until a proportionately high frequency of access requests would make a displacement/copying to one or more other locations expedient. Ideally, such a situation would arise within a concept like the storage grid from Network Appliance, leading to a simplified Information Lifecycle Management approach, as the preliminary storing entities are charged as caching-entities in the Nearline-Storage of the above example.

### 4.3 SMAP_FS

SmApper has to make the attributes of the instantiated smap_base_type object persistent and carry out the procedure as efficiently as possible. Stacking allows us to execute this transparently on a base_type object in the course of every permitted access and thus to trace every modification in an atomic manner. The physical representation of the persistent smap_base_type object is, in principle, independent of that of the base_type object. This means that, theoretically, every physical management system (existing file systems, databases etc.) could be considered for storage purposes.

The reasons why SmApper prefers a file system to a database are as follows:
The Stacking-Layer must be located in the kernel of the selected Appliance-Operating-System. Access to the selected storage management system should take place within the kernel for performance reasons (so that the data buffer does not have to be copied back and forth between user-space and kernel-space) which means that the management system has to be implemented on the kernel side. This would seem to favor choosing a file system as they are generally implemented on the kernel side whereas database management systems tend to run in user-space.
Attributes may be constructed hierarchically, see chapter disclosing the concept of the Base Types above. Hierarchies in databases may be mapped by relations, however, performance suffers on moving lower down the hierarchy when SQL normal forms are adhered to. In the same way, the complexity of maintenance of the database schema increases cumulatively.
SMAP_FS provides a mechanism (QZone) which allows the buffering of files (caching), dispatching them to their target destination only on a well-defined point in time. As files would have to be treated as B(LOB) in a database, performance would once again suffer.
Nevertheless, we would like to point out that while it is technically feasible to draw on a database system as a storage management system, it does not seem to be advantageous to do so at this point in time; however, this aspect may change in the future. One example of an interesting implementation of a file system ‘on top’ of a database is Michael A. Olson's approach which tackles features like querying and transaction security implicitly but which seems unsuitable for SmApper with these benchmarks [12,15].

The reasons why SmApper implements its own file system (SMAP_FS) are as follows:
The file system offered by SmApper must be optimized for so-called Lookups. This means that any search for a smap_base_type or a specific attribute of a smap_base_type as the case may be, must be extremely high-performance. Standard file systems often have to find a compromise specifically for lookups between the optimized locating of metadata entries (inodes) and quick access to actual blocks of data. On the other hand, the SMAP_FS stores the attribute values in the inode itself which leads to much higher performance but also means that only a pre-determined maximum size or length of attribute values can be saved.
SMAP_FS is based on the assumption that, in accordance with the Pareto Analysis, at least 80% of the attribute values will fall within these pre-determined size limits. In all other cases, the value within the SMAP_FS-Inode refers to the actual data stream of the original file, which permits a retrieval of the attribute information but no (SMAP_FS-intrinsic) indexing.
SMAP_FS must permit smap_base_type objects to be identified via an explicit path as well as by query using appropriate attributes. Standard file systems do not implement query interfaces even though exceptions like BeFS, the BeOS file system, would seem to prove the rule [17].
The file system must ensure that the integrity of a smap_base_type is protected at all times, see in addition the system lemma of chapter disclosing SmApper basic functions.
The file system must offer triggers, both conditional triggers (rule_based triggers) as well as unconditional.
The file systems receives additional logic which allows it to apply extractors and converters to data streams while these are being written, which should lead to optimal performance.

The complete design and the implementation description of the SMAP_FS lie well beyond the scope of this technical paper. At this point, it will be sufficient to establish that SMAP_FS is an optimized file system which will
render smap_fs_type objects persistently available
protect the integrity of persistent smap_fs_type objects
ensure the permanent connection between base_type object and smap_base_type object
allow access to the attributes of the smap_fs_type object (directly and indirectly by query)
offer a mechanism which buffers the binary representation of the base_type object and later dispatch it to its static or dynamic target destination
offer versioning possibilities at file and block level.

### 4.4 Access to smap_base_types

One of the most important basic requirements of a SmApper system is access to the extended attributes of the smap_base_type, see the section entitled ‘SmApper—the Basic Requirements’. As the SmApper systems have to be capable of being integrated smoothly into existing infrastructures, access to attributes must occur without any kind of proprietary protocol and must be based exclusively on standards.

SmApper solves this in a unique fashion by combining two standards:
Access via POSIX Standard (by path)
Access via XQuery/XPath (by query)

Access to a base_type occurs via path commands and via the usual POSIX-API like open, read, llseek etc. Extended attributes of the smap base_type are treated like individual files and are therefore also accessible via a (specific) path command as well as via POSIX-API. The following example will serve to illustrate this: the title of the original file (an MS Word document)/home/users/gth/hello.doc was extracted and saved in the attribute title in the SMAP_FS. Access to this attribute now occurs via the path command
/home/users/gth/hello.doc?//title.

The delimiter serves only as an example here and can be configured. The path command is specific in our example and therefore delivers a SMAPFS-file handle when an open-request is demanded. Finally, of course, the usual I/O operations can be carried out using this file handle. Should the attribute allow write-access then a write-syscall will only be successful when the modifications are also reflected in the original document (in our example/home/users/gth/hello.doc)—during an outbound-operation the write-request will be executed without modification to the original document. Should the modification to the original document, which, will of course, not take place until a later date, then fail, the file would be labeled with the corresponding status in the QZone.

Should the path command not lead to a specific SMAPF_FS attribute (suppose, in our example, there were several titles) the path command would be treated as an access to a directory, in that the individual actual attributes could be treated by means of iterative access.

The query capacities of the SmApper namespace can be illustrated in the following examples, however they act in the same manner as in the above example (which is, in effect, nothing more than a very simple query):
hello.doc?//title[position( ) !=1]:
this delivers all the title attributes of the hello document except the first.
hello.doc?//contains(title[position( )==1],confidential):
this delivers a file handle back to the hello document, should the word ‘confidential’ appear in the first title
hello.doc?//titel[position( ) 1]/subtitle:
this delivers the subtitle of the first title attribute of the hello document

The combination of the two standards POSIX, XQUERY enables the SmApper systems to be integrated smoothly into existing infrastructures, as the normal file access has not changed in any way. Access to the extended information of the SMAP_FS also takes place using the standard file I/O, the sole change being the extended path syntax that users, and in particular, applications must use when attribute access is required. As, though, this extended syntax conforms to the accepted standards, its integration should not prove to be a huge investment for application developers.

### 4.5 Rules and Actions

Rules and actions form SmApper's actual compute-layer, allowing decisions to be made and actions to be taken on the basis of the extended information included in a smap_base_type as opposed to a base_type. Rules offers the possibility of forming Boolean Expressions using Boolean Operators AND, OR, NOT and datatype-specific operators, for example, ==, !=, <, >, contains etc.

On the one hand, the attributes of smap_base_type can be considered operands, or even, on the other hand, constants like Literals, time commands like now, today, among others. Rules constitute SmApper's very simple model of the decision-making body. An example for a rule is:
(this_file.summary contains “ABC”) AND
this_file.uid==1001)∥
this_file.size<2048)

A rule always has access to all smap_base_type objects which are located within its scope. There are three ways of bringing an object into the scope:
1. Implicit: during a file system event, the object this_file is always located implicitly in the scope. This is the file which led to the trigger event of the rule.
2. By path: a new object can be instantiated in the scope by a definite SMAP_FS-Path, for example/smap_nm t/x.doc?uid
3. By query: objects can be instantiated by query, see the chapter entitled Access to smap_base_types.

In SmApper, rules constitute the authority which decides whether an Action should be executed or not, and, if so, whether Action A or Action B should be executed. An Action can be any event from sending an email, the encrypting of data, the moving/copying of files within the storage networks, to access to a SAP system. SmApper even considers the extractors and converters previously introduced as actions in the broadest sense.

Owing to the diversity of potential actions, one of SmApper's basic requirements is that it must allow external, third-party applications to be accepted as actions. In the same way, SmApper's second and third basic requirements follow on: it must ensure that the third-party application can in no way compromise the operation of the SmApper appliance. Furthermore, it must be capable of high-performance execution of actions.

These basic requirements are implemented in one of the core areas of SmApper's own operating system, the SmAp-OS, which is based on FreeBSD. While standard operating systems offer the concept of processes and threads as lightweight processes, actions exist in SmAp-OS as a third process abstraction layer, which can be thought of as ultra-lightweight-processes. This action authority operates in a type of Virtual Machine (VM) within the core of the SmAp-OS. This VM enables additional security parameters to be determined, for example:
1. max_time: Maximum duration of the action's execution in the system
2. max_call_depth: How many fork( )/exec( )-calls are permitted?
3. max_file_desc: How many file descriptors are permitted?
4. mem_areas_allowed: Access to which memory segments are permitted (DMA etc.)?
5. max_heap, max_stack: How large may individual memory segments be?
6. networking: Which network protocols are permitted?
7. pre-emptable: Can the action be interrupted?

However, the VM does not simply enable the performance of the actions to be determined, in order to achieve a higher level of security. The VM also provides a separate protected address room, which severs standard processes (system programmes etc.) and the kernel from actions. Should an action crash, then, in a worst case scenario, it would only affect itself and other actions but not the rest or the core of the SmApper system. Moreover, the separate address room provides the capacity for more efficient Context-Switching and for quicker process creation (no more memory areas, which have to be copied etc.) As the SMAP-OS now recognizes the concept of action processes in addition to standard processes and real-time processes, a more granulating scheduling is possible, again leading to higher (or better adapted) performance.

In SmApper, rules and actions can be combined in a very simple but unique way, by using the concept of conditional cloning. With UNIX operating systems programmes are carried out in two stages: firstly, by calling up one of the fork( ) system calls (vfork( ), clone( ) and so on) followed by one of the exec-system calls. Forking creates a copy of the programme which is currently running in memory while the exec-call loads a new programme in the memory which can be carried out. UNIX derivates, in particular BSD and Linux, have implemented extremely efficient ways to start a programme (=process creation) and yet this step still remains one of the most expensive services offered by an operating system. SmAppers conditional cloning allows the kernel to evaluate a rule before calling up the fork( )-syscalls and, depending on the result, to execute the forking plus all the ensuing steps or not.

In order to allow this connection, SmApper has the capacity to load pre-compiled rules into the kernel, where they can be connected with actions via Mapping Tables. This allows, for instance, an application to be started at any time but only when the rule has been complied with will it be carried out—without even causing serious additional cost to the system. A second means of establishing this connection is by calling up the SmApper-specific fork_if( )-syscall (instead of the fork( )-syscalls) which contains the rule-context as a standard parameter.

To summarize, SmApper permits the working or connection of rules and actions at the following junctures:
1. Rule-/Actionframework: A daemon in the user space which is available as a listener for events und pairs rules and actions up. Events may be file system events or timerbased events.
2. Conditional cloning: Carried out in the kernel, it allows a rule-preprocessing before the forking and may either be executed by successful action to rule mapping after a standard-fork( ) or by a dedicated call of a fork_if( )-syscall.

### 5. APPLICATIONS

### 5.1 Features

The following is a list of technical features which a SmApper appliance itself provides partly by means of system implementation as shown in section of chapter the SmApper implementation and partly by means of additional applications (actions, rules etc). This list is not necessarily complete but will indicate some of the possibilities available when using SmApper.

Versioning: Versioning allows the user to create automatic versions of a file. Essentially, SmApper offers three methods of versioning:
complete (each file is a completely new file including its meta data, see WORM),
modifications (only the modified blocks are saved) and
meta data (there is only a physical data file which always corresponds to the last information; however the SMAP_FS retains the attribute information of older versions as read_only).

Semantic file access: This refers to the query-feature in SMAP_FS. The user is no longer only capable of accessing his files by path but also by queries to the attributes of the smap_base_type objects.

Context sensitive security: All the attributes of a smap_base_type object may have different security levels. This means that, for example, a user can see the title of a certain document but may not read the contents.

Hidden files/parts of files: Depending on context-sensitive security, it is also possible to make files, parts of files or even whole directory trees invisible to certain users or user groups. This would give executives, for instance, much higher security levels when storing sensitive information.

Implicit copies: SMAP_FS enables n copies of a file to be created and maintained easily, even in different destinations or file systems.

Conversions: n converters can be defined per scope. This means, for instance, that an incoming TIFF file can be converted automatically into a JPEG, or a thumbnail and a low-resolution preview can be created. When all these new, converted files are added to the original smap_base_type using ‘attach’, SmApper automatically reflects every modification to the original file in the converted extracts. Further examples of automatic converters include compression algorithms (ZIP etc.) and encryption algorithms.

Alerts/Notifications: The (rule-based) triggering function in SMAP_FS allows every user and/or programme to be notified automatically by alarm, message, text-message, email and so on regarding any form of file access. This may be relevant for security reasons but may also be an advantage as a workflow feature or serve to relieve the system administrators.

Statistics: SmApper allows almost unlimited statistics to be recorded via File I/O. Using this tool, it would not only be conceivable to measure when and how often a particular file was opened or modified but also which parts of it were affected. Moreover, it would be possible to keep track of accessing clients in order, for instance, to acknowledge a storage location which. does not correspond to user patterns and therefore seems disadvantageous. Also analysis could be made which would permit an evaluation of data to be performed under the heading ‘What does it contribute to the net product of the company?’.

Replication: Following on from implicit copies, replication means that SmApper enables rule-based replications to be carried out at file as well as block level. A useful replication would mean for example that a file is replicated automatically in a storage location which is more in keeping with user patterns, in order to increase performance (see Statistics).

Distributed data: As the SMAP_FS cancels the direct connection between logical file access and physical file location permanently using the stacking layers, files or parts of files can move within a storage grid in a rule-based way. In other words, this capability merges the caching and storage components which, until now, had been treated separately.

Virtual directories: Using SMAP_FS, files which are physically located in completely separate tree structures or even different file systems can be logically displayed as though they are in one directory. To give a practical example, these could be directories for project groups or virtual company teams

Content integrity: SMAP_FS safeguards the integrity of all attributes of a smap_base_type object, from system-specific attributes to user-defined attributes. This allows a file to be given additional information, whose life cycle is equally linked to the file as its contents.

Several file views: Using the capacity to extract and convert data and then add it as an attribute (or an attribute object) to the original file, it is possible to allow several ways of viewing a file. For instance, a user could preview a CAD document without having installed the CAD application. Newspaper headline editors would be able to view the headline only of a story without having to struggle with the rest of it and even to modify it without needing the full editorial system. As a further variation, there could be a network-specific or even device-specific view of a file. A PDA for example could get a lower resolution than a conventional PC.

Combining of file parts: It is no problem at all to combine several fragments of different files and combine them to create a new file with SMAP_FS. For example, it would be very simple to write all the titles of Word documents in a new document.

Audit trail: Using the versioning feature, it is possible to show who modified what and when, at the binary data level as well as at attribute level.

Conditioned ACLs: SMAP_FS allows not only rigid user/groups entitlements to be assigned but also rule-based access rights. One example of this is that a particular file may only be read and modified by User Y on Day X. Only after 10 p.m. are all users permitted to read the document. An embargo function for product launches or for news items, which are subject to a time blackout, for instance, would be feasible using this feature.

Implementation of digital workflows: This means that SmApper allows different stations in a file's life cycle to become capable of being automated. News wire pictures, for example, which are sent to a publisher, could be processed automatically and directed to the appropriate photo editors; when they are finished, the pictures could be automatically transferred to the repro directory and so on.

Shared task automation: Shared tasks include the printer, fax, tape drives, CD writers, archives, microfilm areas etc. The sending of data to these devices can be managed under rule-based conditions which is equivalent to an intelligent, adaptable spooler.

Multilingual feature: Documents or parts of documents can be translated automatically and, using the “Several views per file” feature, can even be opened in the appropriate language, based, for instance, on the Client-IP address.

Scheduled tasks: Scheduled tasks allow all the above-mentioned features to be carried out at any, pre-defined point in time and not only “On demand”, that is, when File I/O has taken place.

Storage virtualization: SmApper is an implicit storage virtualizer, meaning that n storage devices can be concealed behind it. However, these devices can be perceived in a different form, as m devices, by the user. Storage devices can be combined in a rule-based fashion or may be connected statically.

### 5.2 Modules

The following section introduces the core modules, which SmApper offers in the form of feature packages. Feature packages mean an interaction of features as presented in the previous section. However, each module contains additional tools and topics, which are only implemented within the context of the module, e.g. configuration clients, administrative clients etc. The individual modules are as follows:
Information Lifecycle Management (ILM)
Security
Data management
Workflow

### Information Lifecycle Management (ILM)

The purpose of the module Information Lifecycle Management (ILM) is to enable several physical storage systems (file servers, local drives, (i) SANs) to be combined into logical units and to be presented to the user as such, namely as “new” storage resources. Moreover, it should facilitate a decision based on rules regarding the location at which each file is to be stored. Furthermore, it will allow the system to review even in retrospect whether file X, which was stored at time y in location z, should still be stored there at a pre-defined point in time or whether fundamental parameters have been modified, demanding a new decision. This module hereby allows the user to employ his storage infrastructure in the most efficient and economical manner.

The factors which are of influence to this decision process are the following:
disk utilization
proximity to user (latency)
share access speed/user (stats)
costs per MB
storage technology
security level (depending on whether the drives are mirrored or not etc.)

In order to be able to describe terms like costs per MB, security level etc. reasonably clearly, SmApper introduces its own Device-Description-Language which allows infrastructure elements managed or addressed by SmApper (hard drives, printers, facsimile machines, CD writers, file servers etc.) to be defined, this definition to be deposited in SMAP_FS where it is re-used as an object for ILM decisions. An interesting approach, which deserves to be examined in greater detail at this juncture, is presented in the technical paper entitled “File Classification in self-storage-systems”. [15]. This approach assumes that the storage infrastructure components are self-administering, self-configuring and self-tuning, and are capable of not only describing and recording statistically the behaviour patterns in the utilization of the data stored on them but also of predicting them. This approach would lead to documents being automatically classifiable, which would bring supplementary facilitation in ILM concepts.

### Security:

In its standard form, SmApper only skirts the subject of security (that is, without the security module) and only then in as much as the security mechanisms of the fundamental storage infrastructures are used, their results being binding for SmApper. The security module provides SmApper with a more thorough, more finely granulated data security mechanism. On the one hand, this means that in this case SmApper has to understand external security mechanisms (particularly Active Directories and NIS/NIS+). On the other hand, most of the features discussed in the previous section (context sensitive security, hidden files/parts of files, alerts, conversions etc.) allow a range of combinations of additional security features, which is difficult to be achieved in this degree of automation without SmApper.

### Data Management:

Under the heading of data management, we consider the following topics:
conversions
versioning
multilingual feature
several views of a file

The goal of data management is to simplify to a large extent the actual management of unstructured data via automation using the aforementioned feature packages.

### Workflow:

The purpose of the module ‘Workflow’ is to describe the digital lifecycle of a file, the relevant conditions, events and rules and automate it as good as possible. This module is specifically designed to replace so-called “Polling Daemons” (which track directories according to input and then take certain actions) but it is also designed to replace existing spooling systems (for printers, file servers, burning processes etc). A further use for this module is to permit a connection to a groupware environment.

### 6. CONCLUSION

### 6.1 Related Topics

When it is a question of research and possible methods of resolution “Management of unstructured data using structured meta data” is a very broad field. This section attempts to demonstrate the basic direction of the various approaches to the topic which are generically related in subject matter to SmApper while, at the same time, offering a brief demarcation to SmApper.

The first method of approach is based for the most part on the concept of the so-called Semantic File Systems written by Gifford et al [11]. In the same way as SmApper, the Semantic File System allows data to be extracted via freely defined programmes by means of so-called transducers, then to be saved as Key Value Pairs and finally to be recalled using the query concept of the virtual directories. Gifford's approach enables an indexed meta data structure to be set up parallel to the original file system. The primary differences between the Semantic File System as opposed to SmApper are as follows:
it is implemented as a NFS file system, meaning that no heterogeneous landscapes are possible (as opposed to the VFS SmnApper approach)
it is implemented as software, meaning that maintenance and support appear to be more complex when compared to the SmApper appliance approach
Semantic File Systems only permit intrinsic attributes and therefore no additional, freely defined attributes unlike SmApper
attributes are always read only
no actions, no rules
no specialized file system making meta data persistently high-performance
no meta data hierarchies
only strings and integers are permitted as meta data types
the software runs in userspace resulting in lack of performance in high-performance enterprise applications.

Based on Gifford et al, the so-called hierarchy and content approach [13] shows the extension of the Semantic File Systems concept in the sense that query results no longer provide virtual directories but actual physical directories which can then be modified by the user; although this allows for a high degree of flexibility it also involves different challenges as a result of inconsistency. This latter approach differs to the same extent from SmApper as Gifford et al. does.

Sedar [14] presents a further, interesting alternative in the form of a new file system as a storage location for meta data and data by introducing the concept of semantic vectors. The aim here is to optimize the storage requirement of similar blocks/files using semantic hashing. This approach appears to be very interesting for future reference even though, at the time of publication, it seemed to have a long way to go before the implementation is realizable. The same is true of Gifford et al as opposed to SmApper.

A further related concept to the SmApper paradigm is that of the semantic web. [8, 9] The background of the semantic web concept is best explained in the following quotation from the article ‘The Semantic Web’ in the Scientific American: “ . . . . The Semantic Web is an extension of the current web in which information is given well-defined meaning, better enabling computers and people to work in cooperation . . . ” [8] The Semantic Web is based on the Resource Description Framework (RDF), which, integrates a variety of applications, in particular XML. The authors analyze the advantages and disadvantages of using XML or XML/RDF as a description of the smap-base-type attributes but this has no fundamental bearing on the whole concept. Thus the Semantic Web approach is not a rival concept but could instead be viewed as synergetic to SmApper, see also [16].

One highly interesting approach which could also lead to an improvement in data management is the Storage Grid approach followed by Network Appliance [10]. Storage Grid will be able to aggregate physical storage devices in a logical way, packaging them accordingly in front of the user—the whole procedure independent of protocols, technology and even physical locations. This concept could even make classical storage virtualization solutions obsolete. At present, however, only one manufacturer seems capable of realizing this concept, namely Network Appliance, and even then it is merely a concept which will be realizable solely by using the equipment of that one manufacturer, though this could of course change in time. From the SmApper viewpoint, Storage Grid is an additive concept as storage virtualization is not merely one of the core features of SmApper but in fact imperative for SmApper to be able to implement its features. On the contrary, SmApper allows to unleash the real power of a grid.

There is a multitude of (particularly commercial but also open source) applications, which reproduce parts of SmApper's functionality. Of particular note are Content-Management-Systems, Groupware-Systems, ILM-Systems as well as extended storage concepts. To date, however, the authors are not aware of any concept that is capable of combining the advantages outlined in the section entitled ‘What makes SmApper unique?’

### 6.2 What Makes SmApper Unique?

The uniqueness or innovation of SmApper can be considered from two sides:
1. From an abstract solution oriented point of view
2. From a technical point of view

When it is a question of solution orientation, FIG. 7 will help to demonstrate the innovative nature of the concept. According to this Figure SmApper bypasses all layers from the physical representation to information as the only meta data solution. In contrast to all the other comparable state-of-the-art solutions we have looked at, SmApper does not simply focus on one of the two lower layers (physical data/logical data) but also helps to bridge the gap between logical data and information as such. SmApper achieves this by systemically integrating its new data types (smap_base_types) by means of rules and actions that although syntactically and semantically defined, can be freely selected. This is the missing factor, which we fail to find at all in any of the approaches discussed here.

Or, in other words, FIGS. 8 and 9 help to grasp the paradigm shift made possible using SmApper. While, at present, physical access to files (I want file X) and logical access (I want all files which are important at this point in time and which I have not yet read) run separately from one another, logical access even having to be translated into physical access first of all by a compute-layer (=application), SmApper's namespace concept by_path/by_query enables physical and logical access to be executed simultaneously in a single standard-compliant file-descriptor. Moreover, SmApper integrates the compute-layer into the access transaction by means of rules and actions in such a way that it runs during access, or inbound, which is also innovative.

Technologically speaking, it is primarily the symbiosis of existing or similar models and their refinement, extension and supplementation. Conceptually, SmApper can be defined as a modified, enhanced semantic-file-system approach, which has been extended by object-oriented data type integrity, access methodology and persistence on the basis of stacking, whereby the atomically guaranteed correlation between data and meta data appears innovative. In addition, SmApper lays down a rule and action model in order to be able to carry out decisions and actions with these datatypes in a well-defined framework. It is also a completely new idea to integrate these technological approaches in their entirety in a Blackbox-Principle (appliance) in order to guarantee the end user maximum simplicity and the ability to retain the existing infrastructure.

In addition, contingent on its goal of managing enterprise data, SmApper is streamlined for performance by its design and its implementation. Every relevant, I/O-specific part is carried out in the kernel of the selected operating system. Even parsing in the SMAP_FS can be executed in the kernel.

FIG. 9 shows how SmApper combines logical and physical data access and allows inbound computing during the access process.

### 6.3 SmApper Architecture and Filesystem

The SmApper architecture builds a transparent, three-tiered layer between the compute world and the storage network world. The architecture of SmApper is shown in the diagrammatic representation of FIG. 10 in more detail:

1. vSpace

vSpace is the layer beneath the compute world. The term means volume space and defines a rule-based volume manager.

2. nSpace/aSpace

The nSpace layer represents the namespace part of the filesystem and the application space, the location of the SmApplets' application framework.

3. ispace

iSpace stands for information space and is split into ispace B and iSpace F. iSpace B is the block handler of a filesystem. iSpace F makes it possible to lay a block code emulator over an existing filesystem to simulate block access although a filesystem is acting at the back-end. This trick provides a seamless integration even with existing filesystems.

SmApper's vSpace or Volume Space controls the communication between storage clients and storage servers which uses various protocols such as NFS or WebDAV. vSpace implements a Virtual Filesystem VFS framework which operates on the basis of the so-called stacking methodology. A VFS provides homogeneous access to virtually m heterogeneous filesystem implementations. Stacking allows the parallel deployment of virtually n VFS layers and thus controls the so-called data path by switching synchronously or asynchronously the transitions between the single VFS layers and therefore indirectly the physical filesystem implementations. Lock and Transaction Services ensure data integrity and transaction execution. The layers “Name Space” and “Information Space” reflect SmApper's physical and logical separation of namespace and block handling. Each nSpace represents the namespace part of a filesystem, while each aSpace represents the corresponding SmApplets' application and rule framework which, as plug-ins, can extend the existing filesystem functionality. Each ispace B represents a filesystem's block handler, whereas each ispace F lays a block code emulator over an existing filesystem thus simulating block-based access. Hence, SmApper achieves seamless integration even with existing filesystems. Thus, based on these three layers, SmApper is able to deliver a distributed networked filesystem which is customizable and extendable and uses enhanced filesystem semantics.

### 6.4 Challenges

The primary challenges in the further development of SmApper can be divided into two groups:
1. Appliance
2. Software development

### Appliance:

When the topic of appliance is involved, even the choice of adequate hardware is a challenge in itself. The designing, carrying out and testing alone of test and benchmark scenarios in order to identify key performance criteria, whether for small or large-scale enterprise operations, is highly complex. The hardware should be modulated according to these results. At the moment, SmApper is developing its prototypes on an INTEL SR2300, a 2U-OEM-Server with a E7501-Motherboard, two Xeon processors and 2 GB of memory. Further tests are required to determine whether a concept based on serverblades would be more adaptive to scaling performance levels in the long-term.

### Software Development:

The greatest challenges within the framework of actual software development are:
time
complexity of the kernel modules
transaction security: what is the meaning of ‘atomic’ in the scope of SmApper and how is this safeguarded?
development of parsers (specifically in badly documented formats, e.g. MS Word formats higher than Word97)
complexity in the development of a file system in general
performance and stability of SMAP_FS
distributed SmApper appliances
actions and rules: how is the stability of the whole system safeguarded when carrying out the User-Code?

The illustration of FIG. 9 represents graphically SmApper's fundamental features once again as a tool to monitor and control unstructured or semi-structured digital packs of data.

In the context of the description of an implementation example according to the present invention the square brackets refer to the following references:
[1] School of Information Management and Systems at the University of California at Berkeley, How much Information? 2000, http://www.sims.berkeley.edu/research/projects/how-much-info/index.html, (2000)
[2] S. R. Kleiman, Vnodes: An Architecture for Multiple File System Types in Sun UNIX. USENIX Conf. Proc., pages 238-47, Summer 1986.
[3] Erez Zadok, Jason Nieh, fiST: A Language for Stackable File Systems, USENIX Technical Conference, June 2000
[4] Erez Zadok, Ion Badulescu, Alex Shender, Extending File Systems Using Stackable Templates, USENIX Technical Conference, June 1999
[5] Erez Zadok, Ion Badulescu, A Stackable File System Interface For Linux, LinuxExpo 99, May 1999
[6] Wolfgang Mauerer, Linux Kernelarchitektur Konzepte, Strukturen und Algorithmen von Kernel 2.6, Carl Hanser Verlag, München, Wien, 2004
[7] Robert Love, Linux Kernel Development A practical guide to the design and implementation of the Linux kernel, Sams Publishing, Indianapolis, 2004
[8] Tim Berners-Lee, James Hendler, Ora Lassila, The Semantic Web, Scientific American, May 2001
[9] W3C Semantic Web, http://www.w3.org/2001/sw/Network Appliance, Inc., Storage Grid Architecture, http://www.netapp.com/news/press/2003/20031104.ppt, Slides 10-12, 2003
[11] David K. Gifford, Pierre Jouvelot, Mark A. Sheldon, James W. O'Toole, Jr., Semantic File Systems ACM Symposium on Operating Systems Principles archive, Proceedings of the thirteenth ACM symposium on Operating systems principles table of contents, Pacific Grove, Calif., United States, Seiten 16-25, 1991
[12] Michael A. Olson, The Design and Implementation of the Inversion File System, USENIX Technical Conference, January 1993
[13] Burra Gopal, Udi Manber, Integrating Content based Access Mechanisms with Hierarchical File Systems USENIX Technical Conference, February 1999
[14] Mallik Mahalingam, Chunqiang Tang, Zhichen Xu, Towards a Semantic, Deep Archival File System USENIX conference on File and Storage Technologies, 2002, Monterey, Calif., USA.
[15] Michael Mesnier, Eno Thereska, Gregory R. Ganger, Daniel Ellard, Margo Seltzer, File classification in self-*storage systems, First International Conference on Autonomic Computing, NY, May 2004
[16] Sabin-Corneliu Buraga, An XML-based Semantic Description of Distributed File Systems, RoEduNet International Conference, Iasi, June 2003
[17] Dominic Giampaolo, Practical File System Design with the Be File System, Morgan Kaufmann Publishers Inc., (1999)
[18] Marshall K. McKusick, George V. Neville-Neil, The Design and Implementation of the FreeBSD Operating System, Addison-Wesley Professional, 2004
[19] Marshall K. McKusick, William N. Joy, Samuel J. Leffler, Robert S. Fabry, A Fast File System for UNIX, University of California, Berkeley, USA, 1984
[20] Storage Networking Industry Association, Common Internet File System (CIFS) Technical Reference, www.snia.org, 2002
[21] Sun Microsystems Inc., The NFS Distributed File Service, NFS White Paper, 1995
[22] Andrew S. Tanenbaum, Modern Operating Systems, Prentice Hall, 1992

1-37. (canceled)

38. A process of managing unstructured or semi-structured digital data in a file system, comprising the steps of:
functionally extending the file system by providing a framework for further external logic to be inserted in order to modify the file system's behavior even of existing file systems, and
imposing a structure onto said unstructured or semi-structured data in real time by enhancing existing namespace semantics and
processing independently metadata and data by physically and logically separating namespace and block handlers.

39. A process according to claim 38, wherein when data is accessed, logical access and physical access are executed jointly, whereby a transparent, common access mechanism is implemented for both types of access.

40. A process according to claim 38, wherein logical access is carried out as access to information by metadata.

41. A process according to claim 38, wherein existing file system or semantics are enhanced by added attributes.

42. A process according to claim 41, wherein said attributes act like files and allow a child relationship to a directory or a file or another attribute.

43. A process according to claim 38, wherein files and attached information are logically grouped.

44. A process according to claim 43, wherein grouping functionality belongs to the native semantics of the process allowing these relationships to be maintained atomically.

45. A process according to claim 38, wherein the process is carried out while preserving an atomicity of the sum of all partial transactions regarding all data which is linked to respective source data and/or files.

46. A process according to claim 41, wherein at least one attribute is linked with a data type scheme, allowing the introduction of constraints, and validity schemes.

47. A process according to claim 41, wherein said attributes are indexed for fast further retrieval, using B-Trees, B+-Trees, or Hash-Tables.

48. A process according to claim 38, wherein arbitrarily pre-definable data subsets are extracted when accessing said unstructured data or proprietary structured data.

49. A process according to claim 48, wherein the extracted data subsets are stored as metadata in a structured form.

50. A process according to claim 49, wherein intrinsic and/or extrinsic data subsets are used to form the respective metadata.

51. A process according to claim 48, wherein metadata is created from arbitrarily pre-definable data subsets when unstructured and proprietary structured data is read and written or stored.

52. A process according to claim 39, wherein within the execution of the access a file path is processed which has been enhanced by a Query-Interface.

53. A process according to claim 52, wherein the Query-Interface used in the extended file path constitutes an enhancement of a POSIX-in the form of an XQuery-Standard.

54. A process according to claim 38, wherein a structure is given to unstructured data by attributes which allow database-like retrieval, such that a query procedure is incorporated into the data path.

55. A process according to claim 38, wherein the file system is extended by external functionality through plug-ins.

56. A process according to claim 38, wherein data is subject to a pre-defined and customizable rule and action framework.

57. A process according to claim 55, wherein said rule and action framework allows said plug-ins to be executed within the scope of the file system.

58. A process according to claim 57, wherein said rule and action framework allows the plug-ins to be executed inbound to the file system processing.

59. A process according to claim 57, wherein said plug-ins allow the file system behavior to be modified and adapted according to the results of the processing.

60. A process according to claim 38, wherein partial stages are triggered by well defined events.

61. A process according to claim 60, wherein said partial stages are executed automatically.

62. A process according to claim 38, wherein several file system layers are stacked on top of each other.

63. A process according to claim 62, wherein the stacking of said file system layers is done such that the sum of all single transactions in each sublayer can be treated as a single, atomic transaction.

64. A process according to claim 62, wherein the different file system stacking layers all are executed simultaneously or sequentially.

65. A process according to claim 39, wherein logical access and physical access are separated from each other.

66. A process according to claim 38, wherein the separation of namespace and block handlers is done in a physical, out of band way such that the handlers interact using a network backplane.

67. A process according to claim 38, wherein said physical block handling is coupled with existing namespace semantics and vice versa.

68. A process according to claim 66, wherein block handling handlers are unified in such a way that a virtual block layer is introduced which allows an existing file system to be treated as a physical block device.

69. A process according to claim 66, wherein block handling unification paired with coupling with different namespace semantics is used for a virtualization of existing storage environments.

70. A process according to claim 38, wherein said process is carried out in an individual unit without interference in or modification to an existing structure.

71. A process according to claim 38, wherein existing storage environments are SAN and NAS environments.

72. An appliance for processing unstructured, digital data in a data processing installation that implements the process of claim 38 by assigning resources to connect the appliance to standardized software and hardware interfaces of a respective data processing installation or a respective system network.

73. An appliance for processing the process of claim 38 that is integrated as a closed unit into a data processing installation without interference in or modification to an existing structure of the same data processing installation.

74. An appliance according to claim 73 that includes resources to encompass all levels of the unstructured data, from its physical representation through logical classification to its information content, the information content being edited and adjusted to fall within a well-defined framework of actions and/or decisions.

75. A computer programme product that executes the process according to claim 38.
